(19) United States
(12) Patent Application Publication
(10) Pub. No.: US 2026/0111577 A1
(43) Pub. Date: Apr. 23, 2026

(54) SYSTEM AND METHOD FOR REMOTE DATA COLLECTION ON IOS DEVICES WITHOUT INSTALLED AGENTS

(71) Applicant: Exterro, Inc., Portland, OR (US)

(72) Inventors: Harsh Behl, London (GB); Anthony Roberts, London (GB); Arvind Chigurala, Portland, OR (US)

(21) Appl. No.: 18/921,332

(22) Filed: Oct. 21, 2024

(51) Int. Cl. G06F 21/60

(52) U.S. Cl. CPC G06F 21/606

(57) ABSTRACT

A computer-implemented method includes connecting a mobile device operating an iOS operating system to an endpoint operating a Windows operating system remote agent, establishing a trust relationship between the remote agent and the iOS mobile device, and allowing the remote agent to collect data from the mobile device across one or more networks without an installed agent. A computer-implemented method includes connecting a mobile device using iOS to an endpoint operating a Windows operating system remote agent, establishing a trust relationship between the remote agent and the mobile device, and using the remote agent on the endpoint to collect data from the mobile device across one or more networks.

### TECHNICAL FIELD

This disclosure relates to remote data source collection, more particularly to data source collection for mobile devices.

### BACKGROUND

Organizations want to gather data from their employers or members for a variety of reasons. For example, information technology (IT) staff collect usage data, various organizations gather forensic data for investigations and internal audits, and law firms and legal departments need to gather data related to lawsuits, compliance requirements, mandatory reporting, etc.

Data collection from mobile devices presents unique challenges to acquire data from the mobile device in a safe and secure manner. Many users have Apple® devices such as iPhones® and iPads® as their mobile devices, employing the iPhone Operating System (iOS). Data collection from iOS devices typically requires installing an agent for data collection on the iOS device. This poses security concerns and limits the ability to collect data from devices that are off-network, or only connected by Wi-Fi. Additionally, existing solutions often do not allow seamless data collection without manual intervention.

### BRIEF DESCRIPTION OF THE DRAWINGS

FIG. 1 shows an embodiment of an iOS device and an endpoint on the same wireless network.

FIG. 2 shows a flowchart of an embodiment of a method of collecting data from a mobile iOS device.

### DETAILED DESCRIPTION OF THE EMBODIMENTS

The embodiments here provide the capability of collecting data from mobile devices without having to install an agent on the mobile device. Mobile devices such as those that use the iPhone Operating System (iOS®) are prevalent within many organizations people outside the organization from whom data needs to be collected. As mentioned above, current methods of gathering data from iOS mobile devices involve installing an agent of some type, such as an iOS® agent on the mobile device. This discussion focuses on the use of Windows® agents and iOS devices, but the methods used here may apply in other situations. Note that Windows® is a registered trademark of Microsoft Corporation, and iOS® is a trademark owned by Cisco Technology, Inc.

This discussion uses terms that have specific definitions. As used here, the term “Windows agent” or “agent” refers to executable code that binds every user session. A “remote agent” means an agent operating on a computing device running the Windows operation system, referred to here as an “endpoint,” that can connect with mobile devices to allow the mobile device to access the computing device. A remote agent differs from agents that allow help personnel to access to the computing device while a user is using the device to provide assistance. The discussion here differentiates that type of agent, referred to as “remote assistance,” from the remote agents that connect the mobile device to the endpoint Examples of computing devices include, but are not limited to laptops, desktops, tablets, and servers.

Many versions of Window operating systems that include the remote agent capability. These include, but are not limited to, Windows 7, Windows 10 Pro, Windows 10 Enterprise, Windows 11 Pro, Windows 11 Enterprise, Windows 11 Education, Windows Server 2019, and Windows Server 2022. As used here, the term “Windows operating system” means Window operating systems, include servers, that provide the remote agent capability.

Similarly, the term “iOS” refers to versions of the iOS operating system that have the trust capability to allow users to designated devices that the user trusts. The ability to “Trust this Computer” became available in iOS version 16 and later, including all sub-versions of iOS 16, such as 16.1-16.9, version 17 and further.

When a user logs into a monitored endpoint, the agent begins a backup of data on the mobile based upon a configured recording policy. This capability provides many benefits for data collection needs. The term “installed agents” means agents installed on the endpoint device.

The terms “processor” or “processing device” as used here refers to any hardware component that executes code that causes the component to perform task, such as transmitting, receiving, and operating on data, and establishing connections to other devices, as examples without limitation. This may include general purpose processors, digital signal processors, application specific integrated circuits (ASIC), field programmable gate arrays (FPGA), etc.

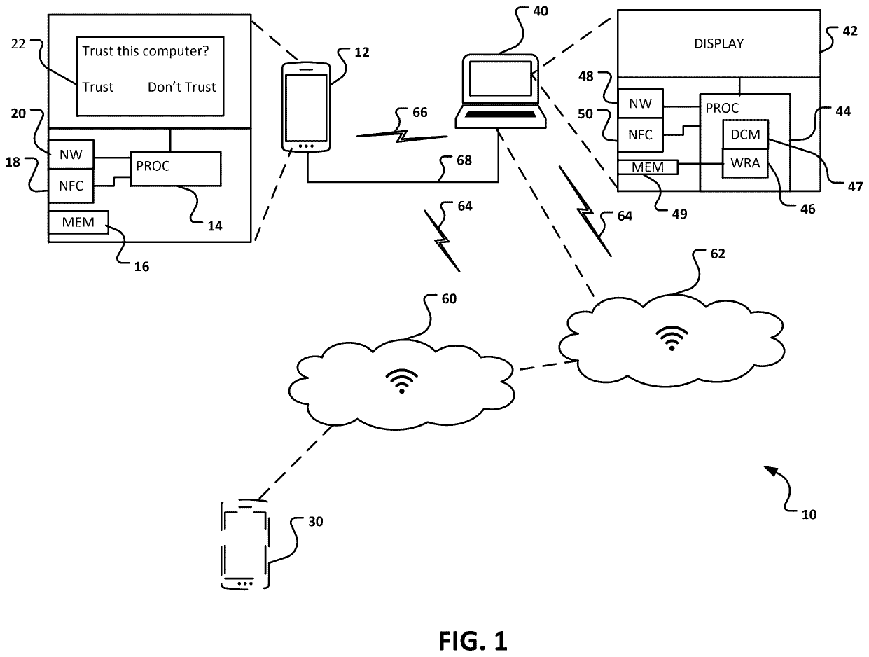

FIG. 1 shows an embodiment of system 10 in which a mobile device 12 establishes a trust relationship between the mobile device 12 and Windows® endpoint 40 having a Windows® remote (WRA) agent operating on it. The mobile device could be any device running iOS, most familiarly iPads® and iPhones®. The Windows® endpoint is any Windows® machine that has, or can have, a Windows remote agent installed.

Windows machine 40 comprises a computing device that runs the Windows® operating system. The computing device includes one or more processors such as 44. The one or more processors are configured to execute code to perform the methods of the embodiments. One such piece of code is the Windows® remote agent (WRA) 46. The one or more processors will access the code for the WRA 46 from the memory 49. The one or more processors will also communicate through communication ports such as network port 48 and near-field communication port 50 to establish a connection between the endpoint and the mobile device. The endpoint device 40 also includes a display 42. This may include one or more touch controls, or the device may have other controls as part of the computing device.

Similarly, the mobile computing device 12 has many of the same elements of the computing device of the endpoint, including one or more processors 14, a memory 16, a near-field communication port 18 and a network interface 20. These operate similar to those found in the endpoint and will be employed to connect to the endpoint as needed. In most iOS mobile devices, the display 22 doubles as the user interface through which the user can provide inputs to the mobile device.

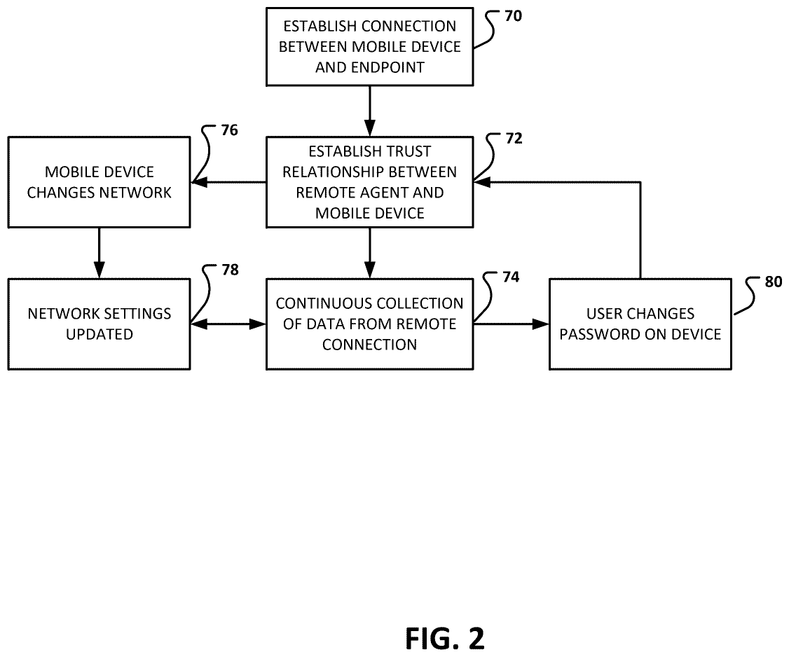

FIG. 1 shows the system, and FIG. 2 shows an embodiment of a method of collecting data from a mobile device without a need for the mobile device to install a remote agent. The network port 48 may comprise a wired connection such as that shown by cable 68 between the endpoint 40 and the mobile device 12. The connection may also comprise a wireless connection, such as a near-field communication (NFC) link 66 such as Bluetooth®, or a wireless communication port to create a Wi-Fi connection 64. The endpoint 40 would connect to the first network 62 to which the mobile device 12 also connects to through another Wi-Fi connection 64, to establish a connection between the two devices. FIG. 2 shows this as 70 in the flowchart.

At 72, the mobile device 12 and the remote agent running on the endpoint 40 establish a trust connection. In one embodiment, the two devices employ the Apple® trust process. When the endpoint connects to the endpoint, the user will receive a message on the mobile device 12, as shown in FIG. 1, asking whether or not the user wants to trust the device. When the user replies to Trust the device, the remote agent on the endpoint will begin collecting data from the mobile device at 74. This process will typically result from one or more processors using a data collection module (DCM) 47. The collection occurs in the background with minimal user interaction, and without the user having to install an agent on the mobile device. Many DCMs exist, such as the Forensic Toolkit (FTK), FTK Central, both provided by Exterro, Inc., Exterro E-Discovery Management (EDDM), Teamscope, REDcap, Magpi, and Jotforms, as a list of examples not intended to be exhaustive.

The established trust connection persists across networks. For example, the user may leave the shared network 62, referred to as on-network, such as work site, and goes home to a second network 62, shown at position 30, referred to as off-network. The position is shown in dashed lines to indicate that the position will change as the device moves. When the mobile device connects to the home network, its network settings will update. The endpoint notes the network changes and will reconnect to the mobile device. The endpoint will continue to send location signals, or “pings,” to the mobile device until the connection is re-established. The trust relationship does not have to be re-established once it has been formed in this instance.

In contrast, assume the user changes the password, or changes some other credential on the device equivalent to a password at 80 in FIG. 2. This will require re-establishment of the trust relationship at 72.

With the establishment of trust relationships, the embodiments provide several advantages. Among these include no agent installation, which eliminates the need for installing potentially intrusive agents on iOS devices. Another advantage lies in the seamless operation because it enables continuous and remote data collection over Wi-Fi or wired connections with minimal user intervention in a flexible manner when the mobile device is on or off network, where on network indicates that the mobile device is connected to an organization's main network, and off network means the mobile device is connected to an external network. Advantages also exist for the information technology (IT) area. For example, the embodiments reduce IT overhead because it allows endpoints to communicate and collect data from iOS devices using already installed windows agents. The embodiments also provide good security because they ensure secure communication between the Windows remote agent and the iOS device.

The discussion here provides several examples to aid in understanding of the embodiments. No limitation to these particular examples is intended nor should any be implied. In a first example, a corporate IT department uses the system to collect usage statistics and diagnostic data from employees' iOS devices connected to the corporate network. The Windows remote agent continuously collects data whenever the devices are within the corporate Wi-Fi range. In another example, an investigation team remotely collects forensic data from an iOS device connected to a home Wi-Fi network. Data could be used for a variety of investigations like HR Investigations, Data exfiltration, IP Theft etc. In another example, in a legal case, a law firm needs to collect data from a client's iOS device. This technology allows data to be collected remotely over Wi-Fi whenever the device is accessible. This ensures compliance with legal discovery requirements while minimizing disruption to the client.

Several applications can employ the embodiments discussed herein. In enterprise IT management, the embodiments allow remote monitoring and diagnostics of employee mobile devices. In the digital forensics area, the embodiments allow for non-intrusive collection of forensic data from mobile devices. In legal and compliance areas, eDiscovery systems can use the embodiments for remote data collection for legal cases, ensuring compliance with discovery requirements. In compliance and auditing systems, the embodiments would ensure mobile devices comply with corporate policies and regulations without requiring constant manual checks. In yet another application, in the public sector and law enforcement area victims can willingly upload data to law enforcement agencies remotely. This avoids the need for physical travel, thereby reducing the burden on victims and enabling quicker, more efficient data collection for investigative purposes.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the embodiments.

What is claimed is:

1. A computer-implemented method, comprising:
connecting a mobile device operating an iOS operating system to an endpoint operating a Windows operating system remote agent;
establishing a trust relationship between the remote agent and the iOS mobile device; and
allowing the remote agent to collect data from the mobile device across one or more networks without an installed agent.

2. The computer-implemented method as claimed in claim 1, wherein establishing the trust relationship comprises:
receiving an alert on a user interface of the mobile device after the mobile device connects to the endpoint; and
receiving a response through the user interface indicating that the endpoint is trusted.

3. The computer-implemented method as claimed in claim 1, wherein connecting the mobile device to the endpoint comprises connecting the mobile device to the endpoint by one of a wired connection, a wireless network connection, or a near-field connection.

4. The computer-implemented method as claimed in claim 1, further comprising updating network settings on the mobile device when the mobile device moves to a different network than that of the endpoint.

5. The computer-implemented method as claimed in claim 1, further comprising reconnecting the mobile device to the endpoint when a password on the mobile device is changed.

6. A computer-implemented method, comprising:
connecting a mobile device using iOS to an endpoint operating a Windows operating system remote agent;
establishing a trust relationship between the remote agent and the mobile device; and
using the remote agent on the endpoint to collect data from the mobile device across one or more networks.

7. The computer-implemented method as claimed in claim 6, wherein connecting the mobile device to the endpoint comprises the endpoint detecting a connection to the mobile device.

8. The computer-implemented method as claimed in claim 6, wherein detecting the connection comprises detecting one of a wired connection, a wireless network connection, or a near-field connection.

9. The computer-implemented method as claimed in claim 6, wherein detecting the connection comprises detecting the connection to the mobile device on a same network as the endpoint.

10. The computer-implemented method as claimed in claim 6, wherein detecting the connection comprises detecting the connection to the mobile device that is off-network from the endpoint.

11. The computer-implemented method as claimed in claim 6, further comprising detecting network settings changes on the mobile device when the mobile device changes networks.

12. The computer-implemented method as claimed in claim 6, further comprising sending location messages when connection is lost with the mobile device.

13. The computer-implemented method as claimed in claim 6, wherein using the remote agent to collect data from the mobile device comprises one of either Exterro Forensic Toolkit (FTK), FTK Central, E-Discovery Data Management (EDDM), Teamscope, REDcap, Magpi, and Jotforms.

14. A computing device, comprising:
one or more processors configured to execute code that causes the one or more processors to:
operate a remote agent;
connect to a mobile device;
establish a trust relationship with one or more mobile devices; and
continuously collect data from the mobile device.

15. The computing device as claimed in claim 1, wherein the one or more processors are further configured to maintain connection with the mobile device wirelessly as the mobile device moves across networks.
